(19) United States
(12) Patent Application Publication
(10) Pub. No.: US 2026/0280994 A1
(43) Pub. Date: Sep. 17, 2026

(54) SYSTEM AND METHOD FOR BLOCKCHAIN BASED AnLF CONSENSUS OVER A DISTRIBUTED UPF NETWORK FOR 6G AND PROCEDURE THEREOF

(71) Applicant: INDIAN INSTITUTE OF TECHNOLOGY KHARAGPUR, KHARAGPUR (IN)

(72) Inventors: Kounteya Sarkar, Kharagpur (IN); Nairit Das, Kharagpur (IN); Sudip Misra, Kharagpur (IN); Aneek Adhya, Kharagpur (IN)

(21) Appl. No.: 19/239,675

(22) Filed: Jun. 16, 2025

(30) Foreign Application Priority Data
Mar. 13, 2025 (IN) 202531022859

(51) Int. Cl. H04L 41/14; H04L 9/00; H04L 41/0894

(52) U.S. Cl. CPC H04L 41/14; H04L 9/50; H04L 41/0894

(57) ABSTRACT

The present invention discloses a method for implementing blockchain-based User Plane Function (UPF) consensus (BlockAnLF) to achieve distributed fail-safe access of Analytics and Logical Function (AnLF) output policies of Network Data Analytics Function (NWDAF) among the said UPFs in a 6G network core user plane. The method comprising the steps of duplication of the AnLF output action policies which are in the form of if-then executables within a blockchain distributed over a network of the UPFs involving each of the UPFs to act as miners in the blockchain and possessing a local copy of the blockchain with itself, where the blockchain consists of a chain of individual blocks with each block consisting of a sequence of the AnLF output policies in encoded format, ensuring a consensus among the UPFs for the blocks of the blockchain involving hash coding of the blocks and validation of such hash codes and involving the UPFs for immediately referring to its local blockchain for retrieving any action policy in case the root AnLF or master AnLF within the NWDAF becomes unresponsive or unavailable.

### FIELD OF INVENTION

The present invention relates to a system and method for BlockAnLF, a blockchain-based User Plane Function (UPF) consensus mechanism for achieving distributed trust among the said UPFs with respect to Analytics and Logical Function (AnLF) output policies of the Network Data Analytics Function (NWDAF) in a 6G Core User Plane network. NWDAF, a key 5G Service-Based Architecture (SBA) function, provides analytics using Model Training Logical Function (MTLF) and further execution through Analytics and Logical Function (AnLF). However, centralized NWDAF failures impact UPFs. BlockAnLF distributes AnLF policies as blockchain blocks across distributed UPFs, ensuring availability. UPFs act as miners, reaching consensus before committing policies. Additionally, a dedicated Nblockupf interface has been proposed for blockchain-related inter-UPF communication, as a realization of the N9 inter-UPF reference point.

### BACKGROUND ART

A prior publication in the Journal of Network and Computer Applications, Elsevier 2020 [https://doi.org/10.1016/j.jnca.2020.102693], reveals a comprehensive and detailed overview of Blockchain applications over 5G including application areas. The paper provides mostly application-layered and application-oriented, service-based blockchain features over 5G, including IoT, but does not provide blockchain-based control of core especially with respect to NWDAF or AnLF. Federated Learning for Distributed NWDAF Architecture discloses a distributed NWDAF architecture with a master NWDAF and several leaf NWDAFs associated with NFs for mainly Federated Learning Purposes and Architecture [IEEE, 2023 26th Conference on Innovation in Clouds, Internet and Networks and Workshops (ICIN)] [10.1109/ICIN56760.2023.10073493]. However, the prior art does not integrate distributed NWDAF with blockchain and neither indicates further distribution of AnLF policies. Further, Federated Learning-Empowered Mobile Network Management for 5G and Beyond Networks: From Access to Core [IEEE, IEEE Communications Surveys & Tutorials 2024, https://www.sciencedirect.com/journal/sustainable-cities-and-society]reveals a good survey about AI integration in 5G System (5GS) and 5G Core (5GC), especially with respect to Federated Learning mentioning about distributed NWDAF, especially one root NWDAF and distributed leaf NWDAFs with local models-leaf NWDAFs associated with NFs like UPF. However, the prior art does not include blockchain or blockchain-related services.

A Distributed NWDAF Architecture for Federated Learning in 5G reported by IEEE International Conference on Consumer Electronics (ICCE) 2022 [10.1109/ICCE53296.2022.9730220], is disclosing one root NWDAF with AnLF and MTLF and several leaf NWDAFs with each NFs, such that the NFs are able to extract information from leaf NWDAFs.

A prior patent, U.S. Pat. No. 10,742,396B2, reveals securing communications for roaming user equipment (UE) using a native blockchain platform. Blockchain-based UE authentication pertaining to registering UE to the network while roaming-Blockchain Roaming Broker integrates with the SBA over Blockchain interfaces. Blockchain used for UE authentication with roaming broker, however, does not feature UPF or data plane functions. Another patent, U.S. Pat. No. 10,491,376B1, relates to systems, devices, and techniques for managing data sessions in a wireless network using a native blockchain platform. The patent teaches selection of Blockchain Authentication Function (BAF) over enterprise Blockchain (external) for managing session request data associated with a User Equipment (UE), which includes blockchain authentication data. However, in this prior art, blockchain is not used over data plane/UPF sessions or any kind of NWDAF data transfer or blockchain-assisted NWDAF functionality. U.S. Pat. No. 10,949,557B2 discloses blockchain-based auditing, instantiation, and maintenance of 5G network slices, wherein blockchain-based network slice management for new UE Registration, more specifically to maintaining, auditing, and monitoring information related to network slices in a 5G network with blockchain are described. Said prior art, however, does not use blockchain with respect to UPF data flows and NWDAF services to NFs, specifically with respect to the 5G/6G data plane.

### OBJECTS OF THE INVENTION

It is thus the basic object of the present invention to provide for a system and method including communication sequences for distributed consensus among UPF miner for blockchain-based AnLF action policy commits and storage at each UPF over a 6G data plane with each UPF holding a local copy of the blockchain with themselves, for achieving constant uptime for AnLF functionalities for each UPF in a distributed UPF data plane network for continuous AnLF availability over a distributed UPF network.

It is another object of the present invention to provide for a system and method involving a fast and authentic repository of AnLF action policies, which a UPF node can securely refer to in the event of the failure of the root AnLF or link congestion of the logical UPF-AnLF interface (via Session Management Function (SMF)) to address the issue of failure of the central NWDAF or on congestion of the NWDAF link.

It is yet another object of the present invention to provide a distributed blockchain associated with a distributed network of a plurality of User Plane Function (UPF) nodes within the high speed 6G data plane which store the output action policies of the AnLF in individual blocks of the blockchain such that the UPFs may immediately refer to its local blockchain for retrieving any action policy in case the root AnLF becomes unresponsive or unavailable.

It is still another object of the present invention to provide for encoding of AnLF action policies and their dependencies in JSON and storing them inside individual blocks of the blockchain for convenient storage and retrieval.

It is further an object of the present invention to provide for a peer-to-peer distributed consensus mechanism among UPFs to mine and generate a new block for the blockchain, wherein the block contains freshly issued action policies in the format of if-then executables by the central root AnLF through a mutual checking and verification of block hashes.

It is yet further an object of the present invention to provide for a new service-based communication interface “Nblockupf” which forms one realization of the N9 reference point for inter-UPF communication in a distributed UPF environment, specifically for BlockAnLF and related communication among the UPFs including mechanism for reaching consensus.

### SUMMARY OF THE INVENTION

Thus, according to the basic aspect of the present invention, there is provided a method for implementing blockchain-based User Plane Function (UPF) consensus (BlockAnLF) to achieve distributed fail-safe access of Analytics and Logical Function (AnLF) output policies of Network Data Analytics Function (NWDAF) among the said UPFs in a 6G network core user plane, said method comprising the steps of:
duplication of the AnLF output action policies which are in the form of if-then executables within a blockchain distributed over a network of the UPFs involving each of the UPFs to act as miners in the blockchain and possessing a local copy of the blockchain with itself, where the blockchain consists of a chain of individual blocks with each block consisting of a sequence of the AnLF output policies in encoded format;
ensuring a consensus among the UPFs for the blocks of the blockchain involving hash coding of the blocks and validation of such hash codes; and
involving the UPFs for immediately referring to its local blockchain for retrieving any action policy in case the root AnLF or master AnLF within the NWDAF becomes unresponsive or unavailable.

In a preferred embodiment, the above method comprises the steps of:
establishing the blockchain instance at nodes of each UPF, where each blockchain includes a series of blocks chained cryptographically, beginning with a genesis block;
receiving, at each UPF node, one or more Analytics and Logical Function (AnLF) action policies generated by the NWDAF, wherein said AnLF policies are formatted as if-then executable statements;
storing the received AnLF policies in a local, unverified policy pool maintained by each UPF node;
generating a new block when a predefined block condition is met, where the new block includes a block body containing a set of AnLF policies formatted in JSON and a block header including metadata such as a block ID, timestamps, previous block hash, and a computed block hash;
calculating a temporary hash value (H_temp) from the block body and the block header excluding the current block hash, and then calculating a final block hash (H_final) by hashing H_temp concatenated with the previous block hash;
transmitting the computed H_final from each UPF node to other UPF nodes via a dedicated interface;
comparing received H_final values with locally computed H_final values to verify consistency of block contents across UPF nodes;
upon successful hash verification by all UPF nodes, appending the newly generated block to the local blockchain of each UPF node; and
enabling retrieval and execution of previously verified AnLF policies from the local blockchain in the event of central AnLF unavailability.

In the above method, the dedicated interface for inter-UPF communication is a service-based interface designated as the Nblockupf interface, configured to transmit only blockchain-related messages.

In the above method, the block header comprises one or more of: block creation timestamp, block mining timestamp, number of policies, block size, and digital signatures for authenticity.

In the above method, the consensus among the UPFs ensures that only the blocks with identical hashes across all the UPFs are committed to the local blockchain, ensuring data immutability and consistency.

In the above method, the encoded AnLF output action policies additionally contain JSON dependencies with other policies in previous blocks.

In the above method, the NWDAF comprises a Model Training Logical Function (MTLF) that either co-exists with or provides trained models to the AnLF for generating output policies.

In the above method, the Nblockupf forms one realization of N9 reference point for the inter-UPF communication in the distributed UPF environment.

In the above method, as and when the root AnLF issues fresh policies, each UPF stores the policies in the pool of unverified action policies and prepares the new block only when a certain number of policies are present in the pool, depending on the block size as fixed by the network administrator.

In the above method, the block holds multiple action policies, and with each policy being a separate JSON entry having its own unique ID, and each policy further subdivided into sub-policies or contain dependencies with other policies that are denoted by their policy IDs and any other relevant data, as and when the case may be.

According to a further aspect of the present invention, there is provided a system for implementing blockchain-based User Plane Function (UPF) consensus (BlockAnLF) to achieve distributed fail-safe access of Analytics and Logical Function (AnLF) output policies of Network Data Analytics Function (NWDAF) among the said UPFs in a 6G network core user plane comprising:
distributed UPFs acting as bridging NF between access RAN and backbone core IP network, said UPFs connected with each other via N9 reference point interface for inter-UPF transfer of data;
SMF and N4 reference points for logically connecting the UPFs to the NWDAF;
separate storages in each of the UPFs for maintaining a pool of non-verified action policies and blockchain consisting of a chain of individual blocks with each block consisting of a sequence of the AnLF output policies in encoded format generated by the NWDAF;
hash encoder for coding a new block of the AnLF output policies from the non-verified action policies and thereby computing a hash code thereof;
Nblockupf interface for transmitting the computed hash code from each UPF to other UPFs of the distributed UPFs;
comparator in each of the UPFs for comparing received hash code with locally computed hash code values of the blocks stored therein to verify consistency of block contents across UPFs;
control unit for appending the newly generated block to the local blockchain of all the UPFs upon successful hash code verification by all UPFs and retrieval and execution of previously verified AnLF output policies from the local blockchain in the event of central AnLF unavailability.

### BRIEF DESCRIPTION OF THE ACCOMPANYING FIGURES

FIG. 1: Standard 5G Service-based Architecture displaying the different NFs.

FIG. 2: Interfacing between NWDAF containing AnLF and NWDAF containing MTLF through Nndwaf interface.

FIG. 3: Proposed BlockAnLF architecture. Only necessary NFs shown.

FIG. 4: Structure of a single block of BlockAnLF.

FIG. 5: Chaining of blocks in BlockAnLF.

FIG. 6: BlockAnLF timing diagram and communication sequences. Only 3 UPFs are shown, extendible to any generic number of UPFs.

FIG. 7: Proposed Nblockupf interface between the UPFs as one realization of the N9 inter-UPF communication.

FIG. 8: AnLF availability state with respect to uptime. Note: from a UPFs perspective, AnLF is always available.

FIG. 9a: Blockchain attack time with increasing number of nodes (median point of attack).

FIG. 9b: Single block commit time with increasing UPF nodes.

FIG. 10: Query time comparison for each single query with increasing blockchain length.

FIG. 11: Cumulative Query Time for Low load condition (500 packets).

FIG. 12: Cumulative Query Time for Medium load condition (2000 packets).

FIG. 13: Cumulative Query Time for High load condition (5000 packets).

### DETAILED DESCRIPTION OF THE INVENTION WITH REFERENCE TO THE ACCOMPANYING FIGURES

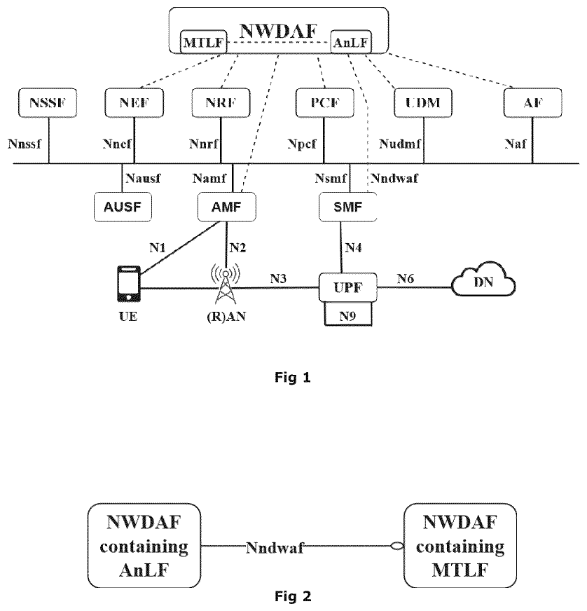

As discussed hereinbefore, the present invention provides for a system and method for blockchain-based User Plane Function (UPF) consensus mechanism (termed as BlockAnLF) for achieving distributed trust among the said UPFs with respect to Analytics and Logical Function (AnLF) output policies of the Network Data Analytics Function (NWDAF) in a 6G Core User Plane. The NWDAF is a Network Function (NF) as defined within the standard 5G Service Based Architecture (SBA) [FIG. 1] whose primary role is to provide various analytics services to different consumer NFs such as the Access and Mobility Function (AMF), Session Management Function (SMF), User Plane Function (UPF) among others by means of executing ML/AI algorithms and predictions. For this, the NWDAF itself gathers relevant network information, flow and User Equipment (UE) data from other NFs and provides its service to the requesting NFs. Specifically, the NWDAF consists of two separate entities, the MTLF (Model Training Logical Function) and AnLF (Analytics and Logical Function). The MTLF is responsible for pre-processing the collected data from the different UEs and training and validating ML models on the same set of data as per specific analytics objectives, while the AnLF is responsible for deploying the trained models that are available from the MTLF and analyze real-time network data based on the trained models to generate predictions and insights.

Thus, while the MTLF works on training and validating ML/prediction models, the AnLF is tasked with providing analytics and prediction outputs based on the trained models by an NWDAF containing MTLF (Refer 3GPP Standard: TS 23.288: Reference Architecture for Data Analytics). It is assumed that the predictive services provided by AnLF can be represented as a set of if-then action policies, where ‘if’ some conditions hold, ‘then’ the corresponding predicted action will be executed. Along with other NFs, the UPFs utilize the services of the AnLF by way of executing routing policies within the 5G/6G core based on analytics results provided by the AnLF. A simple example can be whether to route a packet via a routing path based on the criticality score of the packet. The MTLF within NWDAF has already trained on sufficient data packets (which may include deep packet inspections) and has created a trained model that can predict whether a new packet is malicious or not by assigning with it a criticality score. The AnLF takes in the trained model and actually provides the analytics services to the UPF by predicting the criticality score for a new incoming packet and deciding on the routing path to take for that packet. Specifically, as per TS 23.288 [“Architecture enhancements for 5G System (5GS) to support network data analytics services”, 3GPP TS 23.288 V19.1.0 (2024-12), Release 19], the AnLF can extract the models and trained parameters from MTLF via the Nndwaf interface (FIG. 2) and subsequent Request/Response messages.

An issue with the centralized NWDAF architecture is that on the failure of the central NWDAF or on congestion of the NWDAF link, the service availability of the NWDAF, especially with respect to the AnLF with other NFs, breaks down. While this affects all the related NFs, the UPF also is similarly affected in case of sudden AnLF unavailability, which may lead to a degraded performance, as UPFs primarily deal with routing and forwarding. To mitigate this issue, the invention proposes to have a duplication of the AnLF output action policies (in the form of if-then executables and encoded in JSON) within a blockchain distributed over a UPF network. Each UPF node acts as the miner in the blockchain and possesses a local copy of the blockchain with itself, wherein the blockchain consists of a chain of individual blocks with each block consisting of a sequence of AnLF output policies encoded in JSON. The policies may also additionally contain JSON dependencies with other policies in previous blocks. This invention provides the (a) distributed communication mechanism including the hash value calculation and subsequent exchange of messages among the peer UPF nodes for coming to a consensus of the newly formed block of the blockchain. Each AnLF policy issued by the root AnLF is collected into new blocks and is committed only when they are added to the blockchain after mutual consensus. This makes each UPF to be able to extract the policies and refer to them in an uninterrupted way in the event of the root AnLF unavailability due to failure or congestion. The invention further involves the introduction of a dedicated communication-service-based interface “Nblockupf” among the UPFs for transfer of only blockchain and BlockAnLF-based messages. “Nblockupf” forms one realization of the N9 reference point for inter-UPF communication in a distributed UPF environment, specifically for BlockAnLF and related communication among the UPFs including mechanism for reaching consensus.

Thus, according to basic aspect of the invention there is provided a system and method for a blockchain-based mechanism of achieving distributed consensus among a set of UPF nodes within a high speed 6G data plane core with respect to AnLF action policies:
a. wherein the AnLF is assumed to be present as a root or master AnLF within the NWDAF, and its role is to issue action policies in real time based on the trained predictive algorithms, the training being performed by the MTLF within NWDAF
b. wherein there exists a distributed network of a plurality of User Plane Function (UPF) nodes within the high speed 6G data plane, whose primary task lies in forwarding and routing of User Equipment (UE) packet flows,
   i. wherein the said UPF nodes also subscribe to policies from the AnLF via the SMF and the Nndwaf interface between the NWDAF and the SMF which helps the UPF in determining forwarding decisions in real time based on network predictions
   ii. wherein, being a centralized entity, the AnLF within NWDAF suffers from central point of failure and is at a risk of being unavailable at intermittent times due to sudden failure or link congestion.
   iii. wherein, in such a scenario, it is claimed to have a distributed blockchain associated with each of the plurality of UPFs which store the output action policies of the AnLF in individual blocks of the blockchain such that the UPFs may immediately refer to its local blockchain for retrieving any action policy in case the root AnLF becomes unresponsive or unavailable
   iv. wherein the blockchain and its methods thereof are termed as ‘BlockAnLF’.

In further aspect of the invention is provided a distributed consensus mechanism among the plurality of the UPFs for achieving consensus with respect to the blockchain of the invention:
a. wherein each block of the blockchain consists of a block header and block body, the block body further containing a list of AnLF action policies,
   i. wherein the AnLF action policies within a block body are encoded in JSON including any dependencies that one policy may have with any previous policies.
   ii. wherein as and when the root AnLF issues fresh policies, each UPF stores the policies in a pool of unverified action policies and prepares a new block only when a certain number of policies are present in the pool, depending on the block size as fixed by the network administrator
   iii. wherein after the preparation of a fresh block, each UPF node starts a process of mutual consensus with respect to the freshly prepared block with other UPF nodes present
   iv. wherein each UPF node hashes the contents of the block (header+body), appends it with the block hash of the previous block and performs a hash of the appended data
   v. wherein each UPF node then communicates the calculated hash with every other UPF node, and itself receives the calculated hash value from every other UPF node.
   vi. wherein, if majority of the UPFs agree on the same hash value with each other, a consensus is reached and the calculated hash value becomes the block hash for the newly created block.
   vii. wherein, upon reaching consensus of the newly created block and its block hash among the plurality of the UPFs, the block is added to the local copy of each blockchain associated with each of the plurality of the UPFs, and the process repeats for newly issued action policies from the AnLF.

In another aspect of the invention is provided for a service-based communication interface “Nblockupf” among each of the plurality of the UPFs,
a. wherein the N9 reference point is already proposed as a communication reference point between the UPFs for inter-UPF data transfer,
   i. wherein the proposed “Nblockupf” provides one way of realizing the N9 reference point as a service-based communication interface for blockchain and BlockAnLF-related communications only among the plurality of the UPFs
   ii. wherein the said interface, “Nblockupf,” is expected to provide a better communication abstraction for inter-UPF communication with respect to only BlockAnLF-based data transfer.

A major concern with the existing 5G SBA (FIG. 1) with a centralized NWDAF pertains to the issue of central point of failure. In such a scenario, if the central NWDAF fails, then it will not be able to provide the requisite services to the other NFs. A possible solution towards this issue is a distributed NWDAF architecture which has been proposed especially for federated learning applications over 5G/6G core [Y. Jeon et. al., 2022 IEEE International Conference on Consumer Electronics (ICCE), Las Vegas, NV, USA, 2022, pp. 1-2, doi: 10.1109/ICCE53296.2022.9730220]. This invention develops another alternative distributed architecture using Blockchain over the 6G data plane that solves the central point of failure issue with respect to centralized NWDAF. Specifically, over a 6G data plane with multiple UPFs, there is also an associated Blockchain with the UPF network, with each UPF instance having its own local copy of the Blockchain. The Blockchain stores the list of all the AnLF output policies from the NWDAF that have been issued for use-cases pertaining to the UPF, with new policies being constantly added to the chain as and when issued by the AnLF. Said Blockchain is termed as ‘BlockAnLF’ henceforth. Each block of the BlockAnLF is a sequence of the master AnLF output policies (the one associated with the central NWDAF) in the form of if-then action policies. The action policies may also be dependent on previous action policies, in which case the dependency of each such action policy is included with the said policy. A fixed JSON format is also provided for encoding the action policies, and each block thus holds a JSON hierarchy of action policies (along with their dependencies). As new policies are issued, they are kept in a pool of unmined policies. New blocks are formed by taking such unmined policies from the pool and are added to the Blockchain after a distributed mining process. This invention assumes that the UPFs themselves act as the miner nodes of the BlockAnLF network. The blockchain ensures that exactly the same copies of the action policies are distributed across all UPF miner nodes. In the event of a failure of the central AnLF (or in the event of AnLF link congestion), the UPFs need not wait for the AnLF to recover or the congestion to ease up; instead, each UPF can directly obtain its required action policies from its local copy of the BlockAnLF.

The proposed blockchain methodology also facilitates a secure environment within the 6G core wherein the UPF nodes are authenticated with respect to each other in terms of their shared AnLF policies. Even if any one UPF node fails or becomes malicious, the fact that compromising an entire blockchain is nearly infeasible, through the distributed consensus of BlockAnLF, it is ensured that other nodes that are present and participating can trust communication and policy transfers among each other, being read directly from the blockchain. This makes the 6G core robust and secure in a distributed and decentralized way.

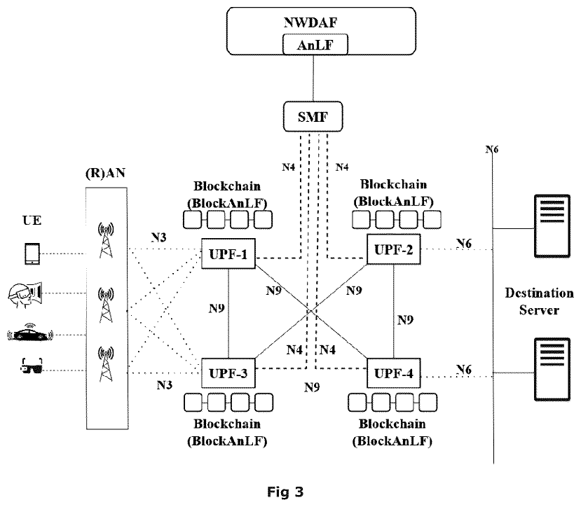

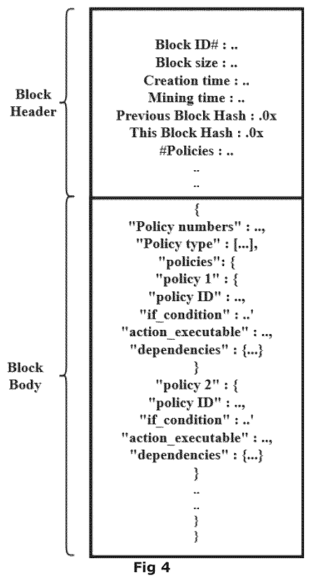

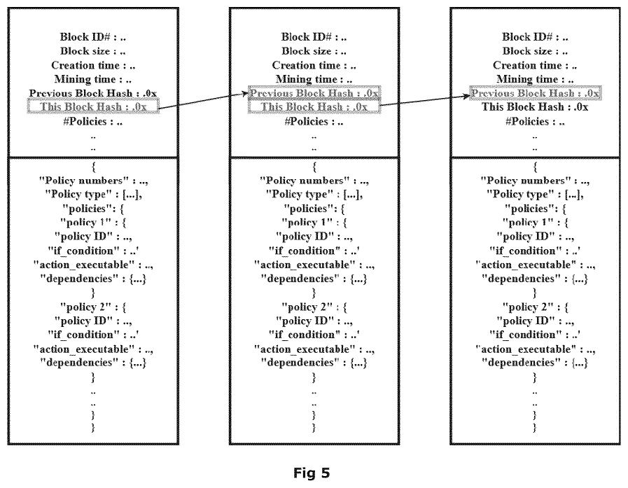

FIG. 3 shows the architecture of the developed BlockAnLF over the 6G core user plane architecture with distributed UPFs acting as the bridging NF between the access RAN and the backbone core IP network. Only the necessary NFs pertaining to this invention, i.e., the NWDAF containing an AnLF and the UPFs, are shown. The UPFs are logically connected to the NWDAF through the SMF via the N4 reference point and subsequently to NWDAF via the Nndwaf interface [N4 between the UPF and SMF and Nndwaf interface between the SMF and NWDAF]. The UPFs are also connected with each other via the N9 reference point interface for inter-UPF transfer of data. UPFs being computational NFs, it is assumed that they are executed over generic purpose computational hardware that can support standard computations, data processing, networking, and has storage and memory. Associated with each UPF is a blockchain of the BlockAnLF, where each local blockchain further consists of a chain of individual blocks starting from the very first block of the blockchain, known as the genesis block. The blocks are chained to each other with the help of cryptographic hash values, where any standard hashing algorithm can be used to generate the hash values. The structure of a single block in the blockchain is shown in FIG. 4. Each block consists of two parts, the block header and the block body. The block header contains metadata about the block, such as the block ID, block creation timestamp, block mining timestamp, previous block hash, current block hash, number of policies within the block, block size, and similar information. The invention does not mandate any specific design and parameters to be considered for the block header, rather it is kept open for implementation as and when required. The block hash is the most crucial aspect of each block as it represents the point with (at) which it is chained with its predecessor block (the genesis block obviously has a default block hash). For each block, the block hash is computed in the following way: the contents of the block header and body are hashed together to give a particular hash value. This hash value is then appended to the previous block's hash. These two appended values together are again hashed with the same algorithm to give the final block hash. The same procedure is followed for every new block that is generated by chaining it with its predecessor block. Such a chaining leads to a linearly increasing data structure that is highly secure, tamper-proof, non-repudiable, and immutable. Additionally, a block is added to the blockchain only after all the miner nodes present in the network have independently verified each other's blocks to ensure that all the blocks contain the same data and the same final block hash. This distributed nature of the blockchain along with its chained character makes it extremely difficult to attack the blockchain and remove or modify its contents. Furthermore, it also ensures redundancy in the same thing is being stored across multiple miner nodes. Thus, a data that is read from the blockchain is assumed to be naturally secure and authenticated. FIG. 5 shows the chaining structure of a blockchain associated with a single node, and the same is replicated across every other node.

FIG. 4 also displays the structure of the block body. It is proposed that the AnLF action if-then policies are represented in JSON structural format which makes it easier for a computer to read and write. Each block may hold multiple action policies, with each policy being a separate JSON entry having its own unique ID, and each policy may further be subdivided into sub-policies or may contain dependencies with other policies that are denoted by their policy IDs and any other relevant data, as and when the case may be. This invention excludes the exact nature, structure, and dependencies of the policies in detail; rather it focuses on the networking and blockchain-based consensus buildup of the action policies for the UPF nodes. Considering FIG. 3 and FIG. 4, the following points outline the methodology of the said invention and BlockAnLF functionality.

The master AnLF or the root AnLF may be co-located with the MTLF within the same NWDAF or it may also acquire the trained model from another MTLF within NWDAF via the Nndwaf interface (FIG. 2). In either case, it is proposed that the AnLF is responsible for producing output action policies in the form of if-then executables which are subscribed by the respective NFs. In the case of UPFs, these action policies may be something such as if a particular flow is predicted to be bursty afterwards, then it should be routed through only a particular path. The UPFs which are connected to the AnLF within NWDAF (via the N4 reference point with the SMF and further via the Nndwaf interface with the NWDAF containing AnLF), request for specific services from the AnLF, the latter which may then respond with appropriate action policies. This ensures that each UPF receives a copy of the output action policies as and when they are released by the AnLF.

Upon receipt of the action policies, they are not immediately committed by each of the UPF; rather, they are committed only when they are verified and put into the blockchain. Each of the UPF nodes maintains a pool of action policies that have not been verified as yet. This pool is maintained as a separate storage by each UPF in addition to the blockchain that each UPF maintains. The BlockAnLF is configured to hold either a fixed number of policies per block or a fixed size of each block, whichever is preferred by the administrator.

When the total number of unverified policies in the pool achieves the requirements for a new block, each UPF node prepares a new block, where the body is formatted in JSON containing the set of all the policies included for this block. The block header is also appropriately configured with the respective details as listed within each block header. The UPF node then hashes all the contents of the block (header and body) into a single cryptographic hash value, appends it with the block hash of the previous block, and again hashes the appended content into a single hash value. For this purpose, the invention proposes the use of any standard hashing algorithm which is cryptographic in nature and maintains the hashing properties. The formula below shows the hashing mechanism followed by each UPF:
H_temp=hash (block body+block header (excluding current block hash))
H_final=hash (H_temp+previous block hash), where H_temp is the hash value obtained by hashing the block contents, i.e. header and body, and H_final is the final block hash. It is noted that since the block hash is also a part of the block header and is not calculated before H_temp, calculation of H_temp does not include the block hash for the current block. Also, as calculation of H_final requires the previous block hash for the genesis block, i.e. the first block of the blockchain, it is proposed to use any default value as the previous hash value.

Once each UPF calculates the H_final of the newly formed block associated with it, the distributed consensus process starts. It is assumed that each UPF in the network possesses the addresses and some security credentials (such as verifiable digital signature through the use of public key cryptography) of every other UPF node. As the UPFs themselves act as miners, every UPF node shares its own calculated hash value H_final with every other UPF node. This sharing may happen though proper encryption mechanisms in order to avoid malicious attacks or eavesdropping. Once a UPF node receives H_final, it compares the received hash value with its own calculated H_final, which automatically ensures that the sender node also has the exact same copy of the action policies and block structure as the recipient node, as guaranteed by the cryptographic properties of hash functions.

The recipient node, upon verifying the hash value, sends an ACK message back to its sender, which allows the sender to know that the recipient has also verified its own calculated hash value. This process is carried out for each pair of sender-recipient nodes of the distributed UPF network. Once each UPF is assured that all other nodes have also verified the same hash value of H_final, it adds the latest generated block to its local copy of the blockchain. Adding the block to the blockchain signifies that the action policies contained within the said block have all been verified and authenticated distributively by all the participating UPF nodes. This makes the freshly released policies, along with all the previous policies in previous blocks, to be immutable and resistant against any kind of future attacks.

As a new block gets verified through the distributed consensus process, new policies that are released by the root AnLF are collected in the unverified pool of policies at each UPF, and once the currently mined block has been added to the blockchain, a new block is generated from the unverified pool of policies, and the same process is followed across all the distributed UPF nodes.

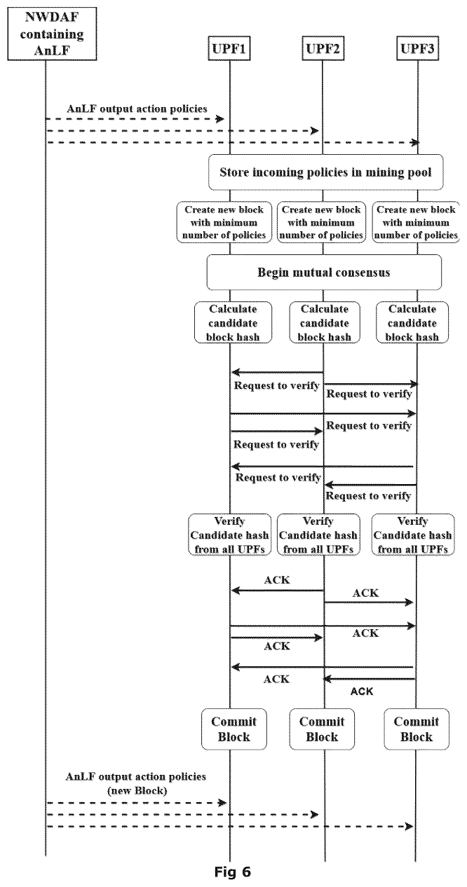

In the event of the failure of the root AnLF or congestion at the root AnLF, each of the UPFs can directly refer to its own blockchain to fetch and execute the respective action policies. The fact that the policies are fetched from an immutable ledger which has been previously verified and authenticated guarantees the trustworthiness of the policies. Each UPF is assured that exactly the same policy is visible across all other UPFs and there is no disagreement or mismatch in their policy executions. This also helps them in achieving distributed consensus among each other in case of any policy dependencies or inter-UPF dependencies in the absence of the centralized AnLF. The UPFs can continue to extract and execute action policies in a secure way until the AnLF goes up and running once again. FIG. 6 displays a timing diagram of the BlockAnLF message sequences between the central AnLF (within NWDAF) and the UPF nodes. For clarity, only 3 UPF nodes have been considered, but the same can be extended for any number of UPF nodes.

### Modified Consensus and Interfacing:

The developed BlockAnLF distributed consensus is different from the standard blockchain consensus mechanisms such as Proof-of-Work (PoW) in the way that BlockAnLF does not propose to have a competition among the UPF miner nodes of finding out a random nonce value that solves a cryptographic puzzle; rather, BlockAnLF simply proposes a distributed verification of the output AnLF action policies through hashing. This can be considered sufficient as within a 6G core, the participating entities such as AnLF and UPFs are well authenticated and communicate through secure channels. The primary role of BlockAnLF is not to achieve authentication among untrusted and unverified parties, but a distributed verification and consensus among the UPF nodes that they all share and possess the exact same copies of AnLF output policies, so that their actions and executions are in synchronization with one another (including dependencies) in the event of the (a) central AnLF failure or downtime.

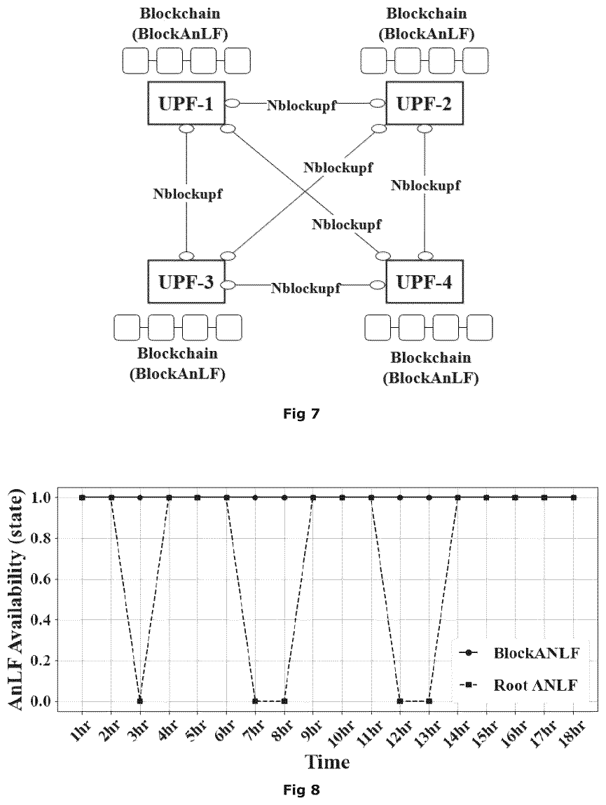

Additionally, since BlockAnLF proceeds via a continuous communication among the UPF nodes, this invention proposes the introduction of a dedicated communication interface among each of the UPFs, namely the Nblockupf interface, which acts as a dedicated communication channel between the UPFs for transfer of blockchain-related information and validation. This Nblockupf interface can be thought of as a service-based communication interface among the UPF nodes for transfer and communication of only BlockAnLF messages. Specifically, Nblockupf provides one realization and utility of the N9 reference point interface already defined for inter-UPF communication (FIGS. 1 and 3). FIG. 7 shows the interfacing between the UPFs with the help of the proposed Nblockupf interface. The said interface is intended to only serve the purpose of peer-to-peer data transfer for BlockAnLF among the UPF and not any other type of communication. This helps in abstracting BlockAnLF communication in a more efficient way. The interface parameters and qualities are proposed to be set by the network administrator as the situation and conditions warrant.

### Analysis:

In order to verify the working methodology of the developed invention and to provide an analysis of the benefit of using blockchain-based AnLF policy execution, the following justifications are provided.

The primary benefit of having BlockAnLF lies in providing a fast and authentic repository of AnLF action policies which a UPF node can securely refer to in the event of the failure of the root AnLF or link congestion of the logical UPF-AnLF interface (via SMF). This eventually leads to a situation where the BlockAnLF can be considered as a sister to the root AnLF, providing continuous uptime to each of the UPF nodes with respect to their associated AnLF policies. FIG. 8 shows the scenario of the benefit of having BlockAnLF from the perspective of a single UPF node which displays the AnLF uptime visible to a single UPF node, both with respect to BlockAnLF and the root AnLF. As FIG. 8 shows, the uptime of BlockAnLF from a UPF's perspective is constant as against the uptime of the root AnLF. This is, of course, assuming that the said UPF node itself is operating and is able to access its local blockchain at all times. Essentially, for each UPF, the composite uptime of the AnLF thus remains constant and independent of the uptime and availability of the root AnLF. The invention thus provides a system and mechanism for continuous AnLF availability over a distributed UPF network.

The second benefit of having BlockAnLF lies in its secure storage of the action policies in an immutable distributed ledger. To understand this aspect, the time taken to attack a single blockchain of a particular length (considering the attack point to be the median block) for a particular node is considered. An experiment was conducted with general purpose computing nodes acting as miners (parameters given in Table 1), wherein it was found that it takes roughly about 10 s for a blockchain with 2000 blocks and 100 s for a blockchain with 4000 blocks to be attacked and compromised, with the point of attack being the median block.

### EXAMPLE

TABLE 1
BlockAnLF Mining parameters

| | |
|---|---|
| No of Miners | Variable |
| N/W Topology | Random Mesh |
| Miner Placement | Random Over Grid |
| Block size | 400 bytes |
| Hash algorithm | SHA256 |
| Miner CPU Type | Intel(R) Core(TM) |
| | i7-8700 |
| Miner CPU Clock | 1 MHzapprox. |
| Miner CPU cores | 12 |
| Miner primary | 8GB max, |
| memory | 7.5GB usable |

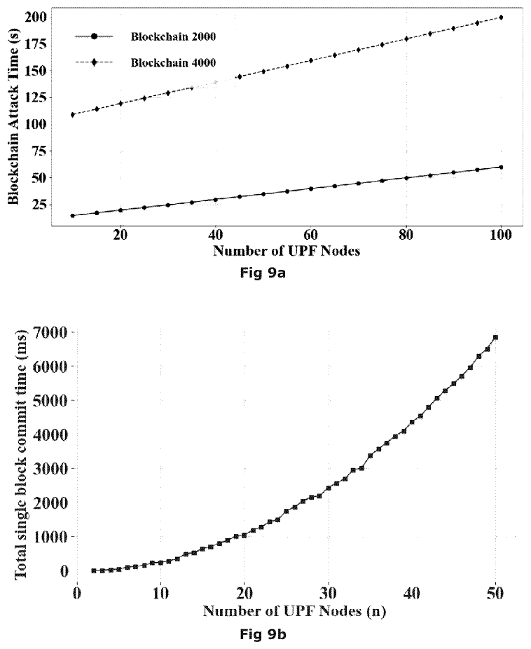

Blockchain being an ever-increasing database, a blockchain of length 2000 or 4000 is indeed reasonable enough. Since a successful attack of the blockchain network involves compromising at least ⅔ of all the blockchain nodes, FIG. 9a shows the time that it takes to successfully launch an attack on two blockchains of length 2000 blocks and 4000 blocks, with increasing number of miner nodes. As can be clearly seen, the time to attack the blockchain increases with an increase in the number of miner nodes. FIG. 9a, in fact, considers the blockchain length to be a constant, whereas in reality the time taken is even more as new blocks are continuously added to the chain, and by the time the attacker launches a successful attack on one miner node, many blocks have already been added to the chain.

FIG. 9b displays the final commit time for each new block within the blockchain, that includes its creation and distributed validation, with increasing number of UPF nodes. An increase in the number of UPF nodes increases the number of message transfers required for block validation, thereby leading to an increasing block creation time. However, as FIG. 9b displays, even with increasing number of nodes, the single block verification-cum-commit time is in the order of milliseconds, which is much less than the attack time of the blockchain (FIG. 9a). Therefore, by the time the attacker completes an attack on a single blockchain, its size increases further by the addition of more blocks. The attacker thus needs to compromise the freshly added blocks across the blockchain as well. This makes a successful attack on the blockchain a non-trivial task. Therefore, any policy obtained from BlockAnLF is inherently secure as guaranteed by the distributed and decentralized nature of the blockchain. This establishes a distributed, decentralized, secure, and trustful environment within the 6G core among the UPF nodes.

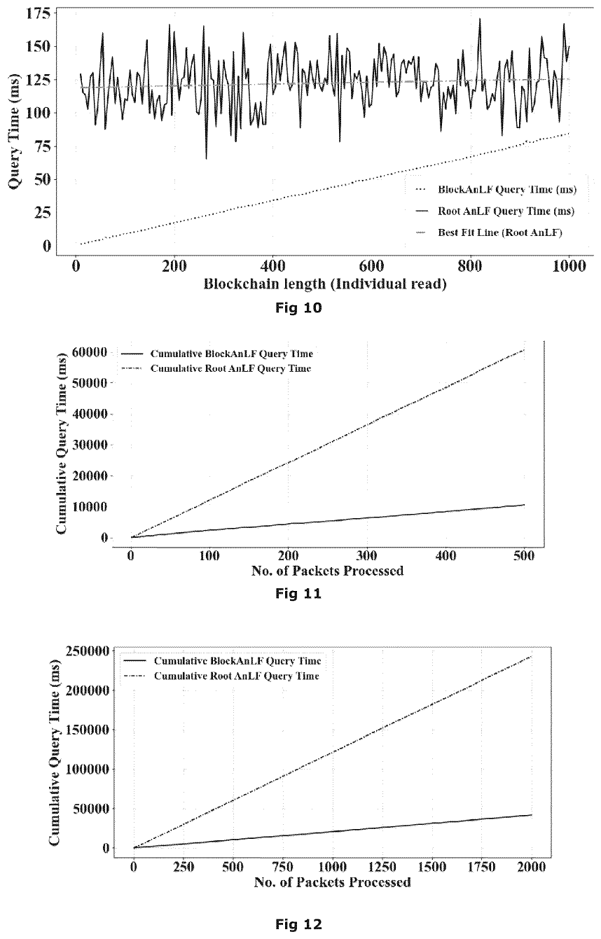

Another major benefit that the proposed scheme achieves is with respect to a significant reduction in query time for individual UPF nodes. In the case of traditional AnLF architecture within NWDAF, each UPF node is required to query the root or master AnLF, which is a remote Network Function with respect to the UPFs in the cloud. In BlockAnLF, the UPF nodes need not query the cloud for retrieving AnLF policies; rather, they can query their local blockchain to retrieve the same. Being verified by the mutual consensus process, it is ensured that the same policies are synchronized across all the UPF nodes. Retrieving a policy from BlockAnLF carries the same security and accuracy as retrieving the same from the root AnLF. In our experiment, we analyzed the time taken to query the root AnLF vs the time taken to query the local blockchain for a single UPF node with increasing number of UPF nodes. While each query to the root AnLF refers to a complete round-trip communication across the core network between the UPF and the AnLF, querying the local blockchain is just a simple file reading operation (each block of the blockchain can be considered as a file in local storage). At most, the local blockchain query may require multiple file reading operations. Being a linearly chained structure, a policy that is stored deep within the blockchain, say at block number ‘X’ from the beginning with total blockchain length of ‘Y’, can be retrieved after accessing the ‘Y-X’ blocks from the end. FIG. 10 provides the comparison between a single query time for BlockAnLF vs the root AnLF, with increasing blockchain length. As an increase in blockchain length increases the expected number of blocks that are required to be accessed linearly, the query time for a single query thus increases with increasing blockchain length. In contrast, the query time for a single root AnLF query is variable as it depends on the network delay, congestion, and other factors. Thus, root AnLF query time is variable, as shown in FIG. 10. However, we note that in spite of increasing query time with increasing blockchain length, the query time for BlockAnLF is significantly lower than even the best fit average value of all the root AnLF query times. This proves that being essentially a local operation, BlockAnLF is much faster in response than root AnLF.

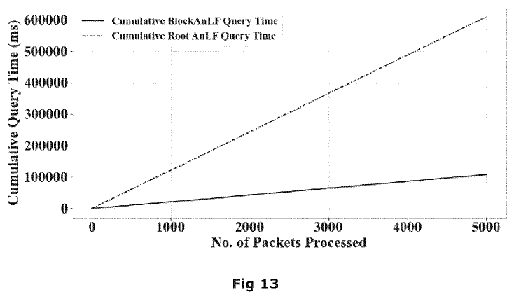

To further substantiate our claim of BlockAnLF expending much less query time, we also show that the cumulative query time expended with increasing application packets is significantly less for the proposed BlockAnLF as against root AnLF queries. This holds true for any application packet loads and data rates. The FIGS. 11, 12, and 13 show the comparison between cumulative time taken to query the BlockAnLF vs the root AnLF with increasing number of processed packets, corresponding to three load conditions (low, medium, and high). Specifically, considering various application types that have different data rate requirements (low, medium, and high), the number of packets processed by the UPF for each such application types are different. As FIGS. 11, 12, and 13 show, irrespective of the data rate and the number of packets processed, the proposed BlockAnLF expends significantly less query time as compared to root AnLF query times. As per our analysis, we specifically find that for any load conditions, about 76.42% benefit is achieved with respect to the cumulative query time for BlockAnLF vs the cumulative root AnLF query time (FIGS. 11, 12, and 13).

The invention therefore intends to include blockchain functionality for AnLF consensus within the standards for future 6G data plane core. The system and mechanism developed herein is found to provide one mechanism of achieving constant uptime for AnLF functionalities for each UPF in a distributed UPF data plane network.

### Advantages of the Present Invention

In the present state of the art, no revelation for a blockchain-based, secure, immutable, and non-repudiable alternative or distributed database for seamless NWDAF and AnLF functionalities is found. Towards this, the present invention provides:
System, method, and architecture for a blockchain-based distributed verification of AnLF output policies over a 6G data plane core with distributed UPFs.
Encoding of AnLF action policies and their dependencies in JSON and storing them inside individual blocks of the blockchain for convenient storage and retrieval.
The system includes the UPF nodes to act themselves as miners of the blockchain network and each UPF holding a local copy of the blockchain with themselves.
A peer-to-peer distributed consensus mechanism among UPFs to mine and generate a new block for the blockchain, wherein the block contains freshly issued action policies in if-then executables by the central root AnLF. The said consensus mechanism proceeds through a mutual checking and verification of block hashes.
A new service-oriented communication interface “Nblockupf” is therefore provided, which forms one realization of the N9 reference point for inter-UPF communication in a distributed UPF environment, specifically for BlockAnLF and related communication among the UPFs, including mechanism for reaching consensus.

1. A method for implementing blockchain-based User Plane Function (UPF) consensus (BlockAnLF) to achieve distributed fail-safe access of Analytics and Logical Function (AnLF) output policies of Network Data Analytics Function (NWDAF) among the said UPFs in a 6G network core user plane, said method comprising the steps of:
duplication of the AnLF output action policies which are in the form of if-then executables within a blockchain distributed over a network of UPFs involving each of the UPFs to acts as miners in the blockchain and possessing a local copy of the blockchain with itself, where the blockchain consists of a chain of individual blocks with each block consisting of a sequence of the AnLF output policies in encoded format;
ensuring a consensus among the UPFs for the blocks of the blockchain involving hash coding of the blocks and validation of such hash codes; and
involving the UPFs for immediately referring to its local blockchain for retrieving any action policy in case root or master AnLF within the NWDAF becomes unresponsive or unavailable.

2. The method as claimed in claim 1, comprising the steps of:
establishing the blockchain instance at nodes of each UPF, where each blockchain includes a series of blocks chained cryptographically, beginning with a genesis block;
receiving, at each UPF node, one or more Analytics and Logical Function (AnLF) action policies generated by the NWDAF, wherein said AnLF policies are formatted as if-then executable statements;
storing the received AnLF policies in a local unverified policy pool maintained by each UPF node;
generating a new block when a predefined block condition is met, where the new block includes a block body containing a set of AnLF policies formatted in JSON and a block header including metadata such as a block ID, timestamps, previous block hash, and a computed block hash;
calculating a temporary hash value (H_temp) from the block body and the block header excluding the current block hash, and then calculating a final block hash (H_final) by hashing H_temp concatenated with the previous block hash;
transmitting the computed H_final from each UPF node to other UPF nodes via a dedicated interface;
comparing received H_final values with locally computed H_final values to verify consistency of block contents across UPF nodes;
upon successful hash verification by all UPF nodes, appending the newly generated block to the local blockchain of each UPF node; and
enabling retrieval and execution of previously verified AnLF policies from the local blockchain in the event of central AnLF unavailability.

3. The method as claimed in claim 2, wherein the dedicated interface for inter-UPF communication is a service-based interface designated as Nblockupf interface, configured to transmit only blockchain-related messages.

4. The method as claimed in claim 2, wherein the block header comprises one or more of: block creation timestamp, block mining timestamp, number of policies, block size, and digital signatures for authenticity.

5. The method as claimed in claim 1, wherein the consensus among the UPFs ensures that only the blocks with identical hashes across all the UPFs are committed to the local blockchain, ensuring data immutability and consistency.

6. The method as claimed in claim 1, wherein the encoded AnLF output action policies additionally contain JSON dependencies with other policies in previous blocks.

7. The method as claimed in claim 1, wherein the NWDAF comprises a Model Training Logical Function (MTLF) that either co-exists with or provides trained models to the AnLF for generating output policies.

8. The method as claimed in claim 3, wherein the Nblockupf forms one realization of N9 reference point for the inter-UPF communication in the distributed UPF environment.

9. The method as claimed in claim 1, wherein as and when the root AnLF issues fresh policies, each UPF stores the policies in the pool of unverified action policies and prepares the new block only when a certain number of policies are present in the pool, depending on the block size as fixed by the network administrator.

10. The method as claimed in claim 1, wherein the block holds multiple action policies and with each policy being a separate JSON entry having its own unique ID and each policy further subdivided into sub-policies or containing dependencies with other policies that are denoted by their policy IDs and any other relevant data, as and when the case may be.

11. A system for implementing blockchain-based User Plane Function (UPF) consensus (BlockAnLF) to achieve distributed fail-safe access of Analytics and Logical Function (AnLF) output policies of Network Data Analytics Function (NWDAF) among the said UPFs in a 6G network core user plane comprising:
distributed UPFs acting as bridging NF between access RAN and backbone core IP network, said UPFs are connected with each other via N9 reference point interface for inter-UPF transfer of data;
SMF and N4 reference point for logically connecting the UPFs to the NWDAF;
separate storages in each of the UPFs for maintaining a pool of non-verified action policies, and blockchain consists of a chain of individual blocks with each block consisting of a sequence of the AnLF output policies in encoded format generated by the NWDAF;
hash encoder for coding a new block of the AnLF output policies from the non-verified action policies and thereby computing a hash code thereof;
Nblockupf interface for transmitting the computed hash code from each UPF to other UPFs of the distributed UPFs;
comparator in each of the UPFs for comparing received hash code with locally computed hash code values of the blocks stored therein to verify consistency of block contents across UPFs; and
control unit for appending the newly generated block to the local blockchain of all the UPFs upon successful hash code verification by all UPFs and retrieval and execution of previously verified AnLF output policies from the local blockchain in the event of central AnLF unavailability.
